(19) United States
(12) Patent Application Publication
(10) Pub. No.: US 2025/0386831 A1
(43) Pub. Date: Dec. 25, 2025

(54) APPARATUS FOR LOADING SLICES OF MEAT ON A FRAME

(71) Applicant: VE.MA.C. Societa' a Responsabilita' Limitata, Castelnuovo Rangone (IT)

(72) Inventor: Maurizio COSTANTINI, Spilamberto (IT)

(73) Assignee: VE.MA.C. Societa' a Responsabilita' Limitata, Castelnuovo Rangone (IT)

(21) Appl. No.: 19/246,084

(22) Filed: Jun. 23, 2025

(30) Foreign Application Priority Data
Jun. 24, 2024 (IT) 102024000014446

(51) Int. Cl. A22C 15/00; A22C 17/00

(52) U.S. Cl. CPC A22C 15/001; A22C 17/0093

(57) ABSTRACT

An apparatus for loading slices of meat onto a storage and conveying frame includes a: feeding device for feeding slices of meat to an inlet end of the apparatus, weighing device for weighing the slices of meat, dosing device that includes a first conveyor belt and second conveyor belt, placed side by side, and feeds single slices of meat to a work table including a third conveyor belt; the apparatus further includes a loading device configured to load the slices of meat on support rod.

### BACKGROUND OF THE INVENTION

This invention relates to the meat-processing sector, in particular the dried meat production sector, possibly aromatized and/or smoked, like, for example, so-called beef jerky.

### PRIOR ART

In the industrial production of beef jerky, defatted meat, for example beef or pig meat, is cut into thin slices in the form of strips, which are marinated, for example with spicy sauces, spices, salt and other aromas and are subsequently loaded onto frames to be subjected to drying and/or smoking at a low temperature, in suitable ovens.

The frames comprise a series of rods, arranged on superimposed planes, astride which the slices of meat are arranged.

This operation has been until today performed by personnel who load the slices of meat onto the individual rods and then arranges the thus loaded rods on the frames, which are provided with appropriate rod-resting and supporting elements.

This operation requires a considerable amount of time and the use of numerous workers, with a resulting increase in production time and costs.

Further, the slices of meat, that, after marinating, are very slippery, can fall to the ground whilst the rods are loaded onto the frames, if they are positioned incorrectly on the rods, and have to be rejected, with a resulting financial loss.

### SUMMARY OF THE INVENTION

One object of the present invention is to remedy the aforesaid problems by speeding up the operations of loading slices of meat onto frames, for subsequent drying and/or smoking.

Another object of the present invention is to slash the number of personnel used in the aforesaid operations of loading the slices of meat on the frames.

A further object of the present invention is to minimize the risk that slices of meat may fall onto the ground and thus be rejected during the operations of loading onto frames.

The above objects are achieved by an apparatus for loading slices of meat on a frame according to claim 1.

Owing to the invention, it is possible to load the slices of meat onto the rods of the frame rapidly, reducing significantly the time required by loading operations, further minimizing the personnel assigned to loading operations and minimizing the rejects due to slices of meat falling accidentally to the ground during loading operations.

### SHORT DESCRIPTION OF THE DRAWINGS

Further features and advantages of the invention will be clear from the description that follows by way of an example of an embodiment of the invention, which is provided merely by way of non-limiting example with reference to the attached drawings, in which:

FIG. 1 is a perspective view of an apparatus for loading slices of meat onto frames comprising a plurality of rods, arranged on superimposed planes;

FIG. 2 is an elevation view of the apparatus of FIG. 1;

FIG. 3 is an enlarged detail of FIG. 1;

FIG. 4 is a perspective view of the detail of FIG. 3;

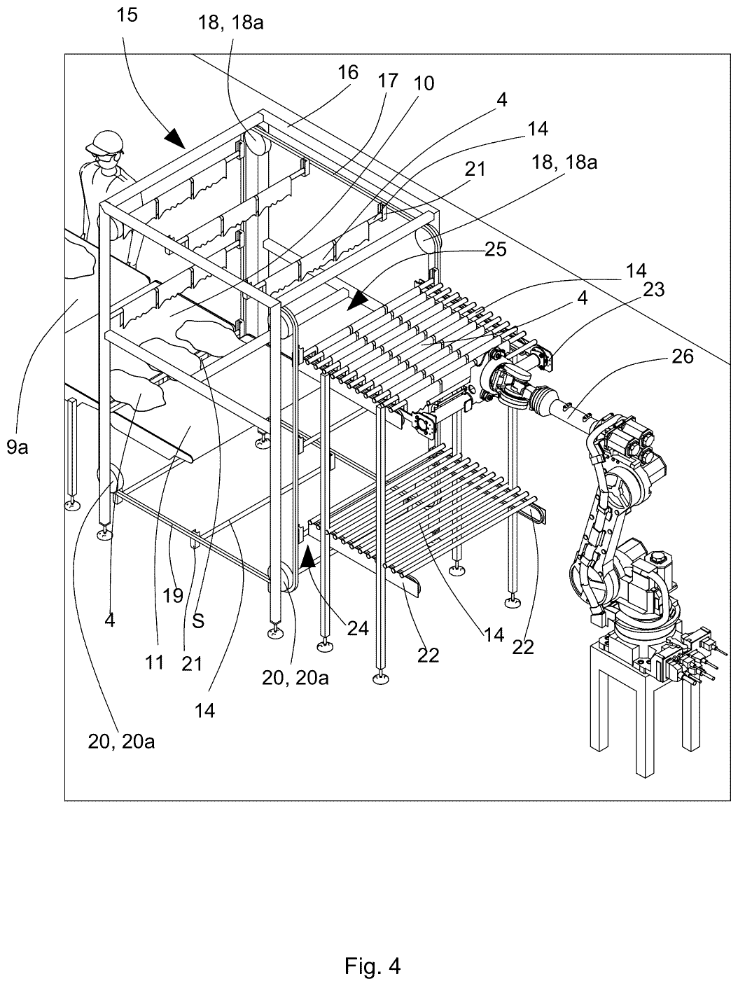

FIG. 5 illustrates a frame on which the slices of meat are loaded.

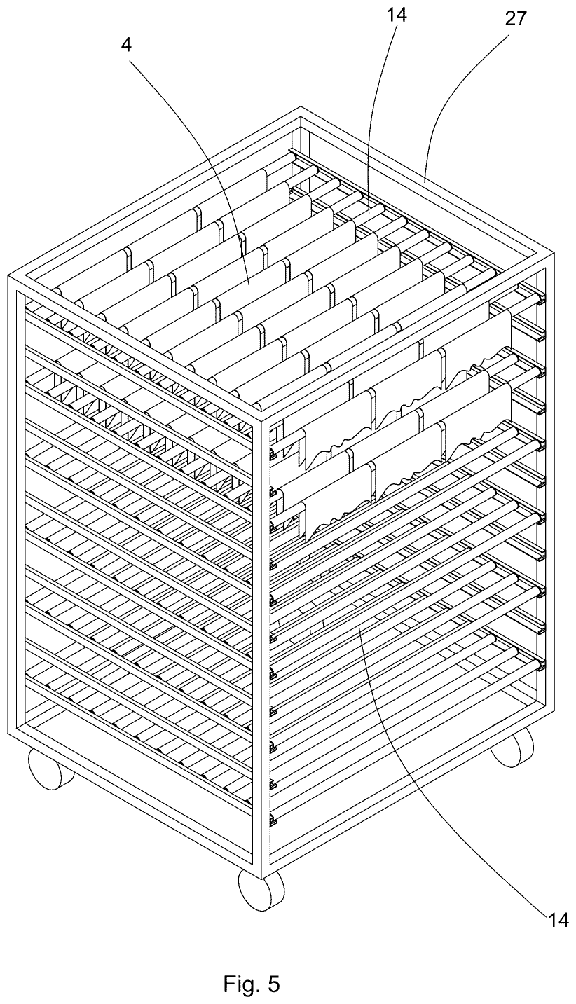

### DETAILED DESCRIPTION OF THE INVENTION

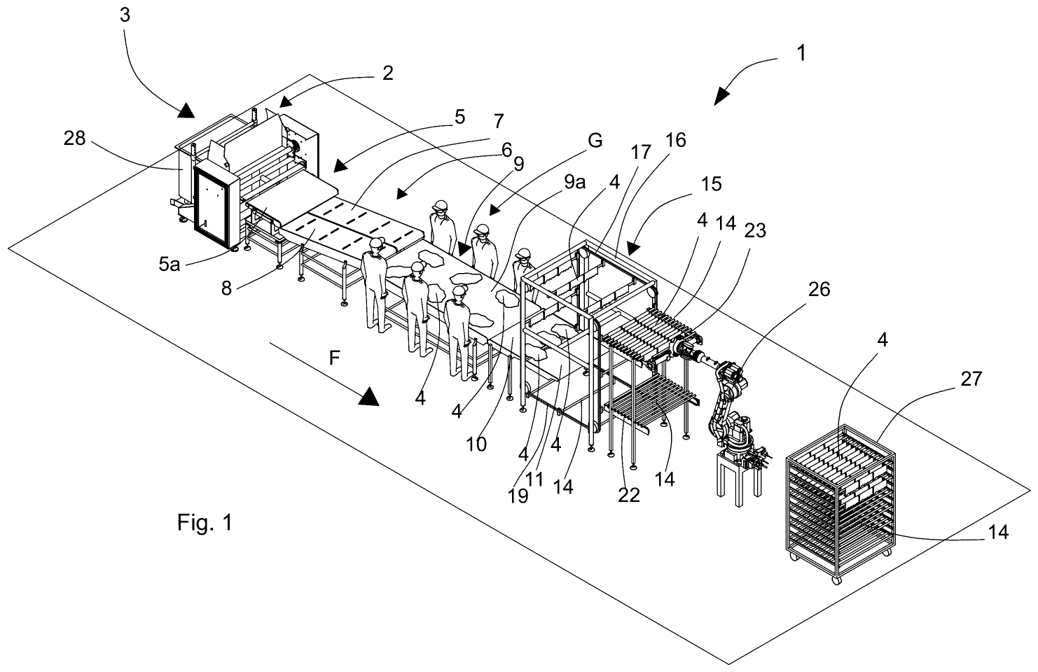

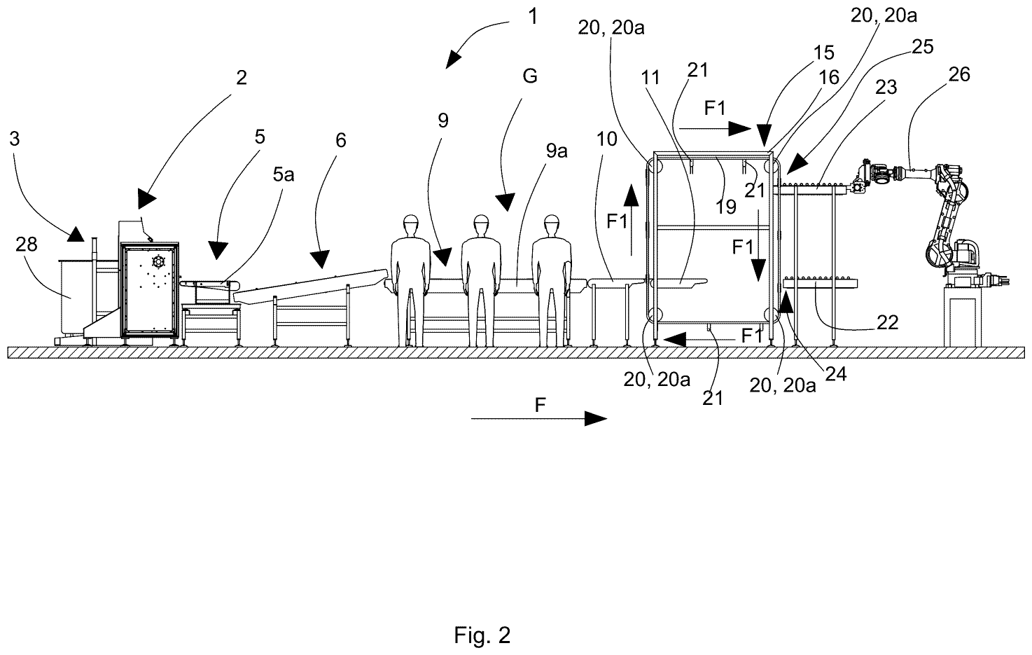

With reference to FIGS. 1 and 2, an apparatus 1 according to the invention comprises a feeding device 2, placed at an inlet end 3 of the apparatus 1.

The feeding device 2 comprises an overturning mechanism that is used to overturn a container 28, containing slices of meat 4 already subjected to marinating. The slices of meat 4 are thin slices in the form of a strip as it were.

Overturning the containing drops the slices of meat 4 on a weighing device 5, comprising a weighing belt 5a, that weighs the slices falling thereupon.

The weighing belt 5a is operationally associated with the feeding device 2, to command the overturning mechanism of the container, such that the weight of the slices of meat 4 dropped onto the weighing belt 5a does not exceed a preset value.

The weighing belt 5a conveys the slices of meat to a dosing device 6 comprising a first conveyor belt 7 and a second conveyor belt 8, placed side by side, which can move independently of one another, such as to feed the slices of meat 4 individually to a work table 9 comprising a third conveyor belt 9a.

A group of operators G arranges the slices of meat 4 manually on the third conveyor belt 9a, which conveys the slices of meat 4 to a fourth conveyor belt 10, that is part of a loading device 15, by which the slices of meat 4 are loaded onto support rods 14.

The operators G arrange the slices of meat 4 on the third conveyor belt 9a, such that all the slices of meat 4 have the same orientation and are arranged substantially aligned along aside one another in rows oriented transversely to an advancement direction F of the third conveyor belt 9a and of the fourth conveyor belt 10, indicated with an arrow in the FIGS. 1 and 2.

The fourth conveyor belt 10 advances the rows of slices 4 of meat, in the

advancement direction F, to a fifth conveyor belt 11, being also part of the loading device 15 and aligned with the fourth conveyor belt 10, in the advancement direction F.

Between a distal end 12 of the fourth conveyor belt 10 and a proximal end 13 of the fifth conveyor belt 11 a space S exists the width of which can be varied.

The terms “distal” and “proximal” refer to the advancement direction F.

The fifth conveyor belt 11 can move in said advancement direction F with respect to the fourth conveyor belt 10, between a first position in which the space S has a minimum width, for example below a minimum thickness of the slices of meat 4, such as not to allow a slice of meat 4 to drop to the floor through the space S, and a second position, in which the space S has a maximum width, such as to enable a support rod 14 to pass through the space S, over which the slices of meat 4 are intended to be arranged.

The loading device 15 further comprises a parallelpipedon-shaped frame 16, on which are supported:
a first conveying device 17, for example a first chain conveying device, closed in a loop and guided by four first chain sprockets 18, arranged at four first vertices of the frame 16, or a first belt conveyor closed in a loop and guided by four first pulleys 18a arranged at four first vertices of the frame 16
a second conveying device 19, for example a second chain conveying device, closed in a loop and guided by four second chain sprockets 20, arranged at four second vertices of the frame 16, opposite the four first vertices, or a second belt conveyor closed in a loop and guided by four pulleys 20a, arranged at four second vertices of the frame 16, opposite the four first vertices.

Pendulum support elements 21 arranged in pairs are fixed to the first conveying device 17 and to the second conveying device 19 with a first support element 21 of each pair arranged on the first conveying device 17 and with a second support element 21 of each pair arranged on the second conveying device 19, so that each pair of elements 21 can support opposite ends of a respective support rod 14.

The first conveying device 17 and the second conveying device 19 move synchronously at the same speed.

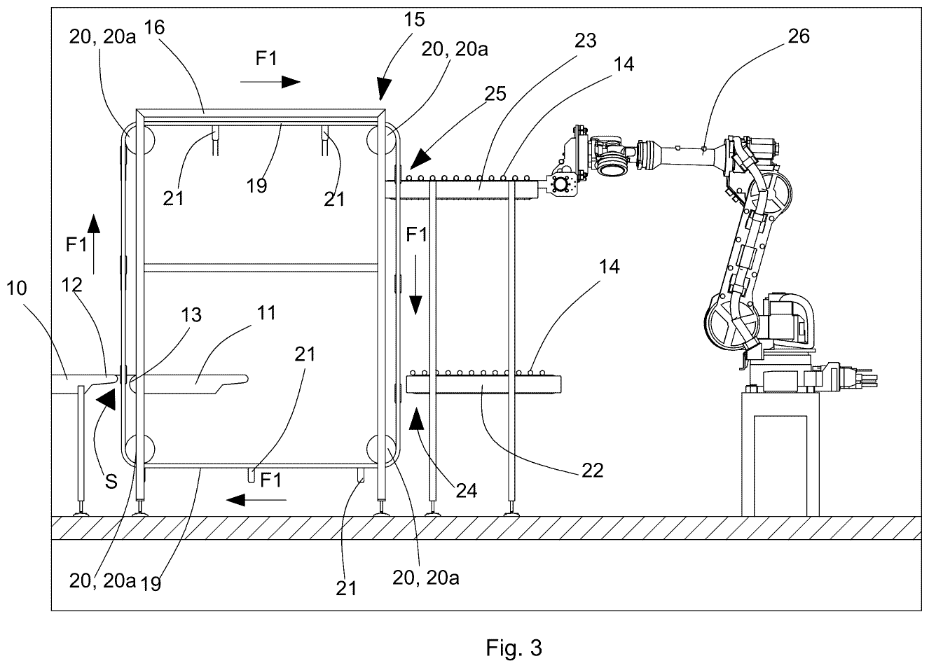

The first conveying device 17 and the second conveying device 19 convey the rods 14 along a loop path, indicated with arrows Fl in FIGS. 2 and 3, which passes through the space S between the fourth conveyor belt 10 and the fifth conveyor belt 11.

The first conveying device 17 and the second conveying device 19 are operationally associated with a third conveying device 22, for example a third chain, or belt, conveying device, configured to transfer empty support rods 14 to the loading device 15, and with a fourth conveying device 23, for example a fourth chain, or belt, conveying device, configured to receive from the loading device 15 support rods 14 loaded with the slices of meat 4.

The third conveying device 22 moves by steps to transfer each empty support rod 14 to a respective pair of pendulum support elements 21 of the loading device 15, in an inlet zone 24 of the loading device 15.

Also, the fourth conveying device 23 moves by steps, so as to receive from the loading device 15 support rods 14, loaded with slices of meat, in an outlet zone 25 of the loading device 15.

In order to load the slices of meat 4 onto the support rods 14, the fifth conveyor belt 11 is taken to said first position, so that the space S assumes said minimum value, then the fourth conveyor belt 10 is driven that advances the rows of slices of meat 4 arranged thereupon, until a first row of slices of meat 4 is arranged over the space S.

Then the fourth conveyor belt 10 stops.

The loading device 15 is then started, which receives an empty support rod 14 from the third conveying device 22, in the inlet zone 24, and conveys the support rod 14 along said loop path, to the space S between the fourth conveyor belt 10 and the fifth conveyor belt 11.

When the support rod 14 reaches the space S, the fifth conveyor belt 11 moves to said second position, such that the width of the space S increases until the rod 14 is allowed to move through the space S.

When the support rod 14 passes through the space S, the slices of meat 4 of the first row di slices of meat 4 are arranged automatically over the support rod 14, being thus picked up by the latter.

The support rod 14, loaded with slices of meat 4, is conveyed along the loop path until reaching the outlet zone 25 of the loading device 15, where it is deposited on the fourth conveying device 23.

The loading procedure is repeated until all the rods 14 present on the third conveying device 22 are removed, each row is loaded with a row of slices of meat 4 and transferred onto the fourth conveying device 23.

When all the support rods 14, initially present on the third conveying device 22, have been loaded with rows of slices of meat 4 and transferred to the fourth conveying device 23, a transferring device 26, for example an anthropomorphic robot, removes the support rods 14 loaded with slices of meat 4 from the fourth conveying device 23 and deposes the rows of slices of meat 4 on a storage and conveying element 27, in the shape of a frame, to then remove empty support rods 14 therefrom and depose the empty support rods 14 on the third conveying device 23, such as to fill the third conveying device 23 with the empty rods 14.

The storage and conveying frame 27, after being filled completely with rods 14, loaded with slices of meat 4, is used to transfer the slices of meat 4 for subsequent processing, such, for example, drying, or smoking.

The fourth conveyor belt 10, the fifth conveyor belt 11, the third conveying device 22 and the fourth conveying device 23 are synchronized with the first conveying device 17 and the second conveying device 19, such that the latter can move without interruption during removal of the support rods 14 from the third conveyor 23, loading the rows of slices of meat 4 onto the support rods 14 and transferring the support rods 14, loaded with slices of meat 4, onto the fourth conveying device 23, so as to minimize the time required to load the slices of meat 4 onto the support rods 14 and load the latter onto the storage and conveying frame 27.

1. Apparatus for loading slices of meat onto a storage and conveying frame comprising a feeding device for feeding slices of meat to an inlet end of the apparatus, a weighing device for weighing the slices of meat, a dosing device that feeds single slices of meat to a work table, wherein the dosing device comprises a first conveyor belt and a second conveyor belt, placed side by side, wherein the work table comprises a third conveyor belt belt, wherein it further comprises a loading device configured to load the slices of meat onto support rods, wherein the loading device comprises:
a fourth conveyor belt and a fifth conveyor belt that are aligned in an advancement direction of the fourth conveyor belt, wherein between a distal end of the fourth conveyor belt and a proximal end of the fifth conveyor belt a space of variable width exists, wherein the fifth conveyor belt is movable in said advancement direction between a first position in which the space has a minimum width, such as not to enable a slice of meat to fall into the space, and a second position, wherein the space has a maximum width, such as to enable the passage of a support rod through the space,
a first conveying device and a second conveying device fixed to a frame and configured to convey the support rods along a loop path that passes through the space.

2. Apparatus according to claim 1, wherein the feeding device comprises an overturning mechanism configured to overturn a container containing slices of meat, so as to drop the slices of meat contained in said container onto a weighing belt of the weighing device.

3. Apparatus according to claim 2, wherein the weighting belt is operationally associated with the feeding device, so as to control the overturning mechanism of the container.

4. Apparatus according to claim 1, wherein the first conveyor belt and the second conveyor belt can move independently of one another.

5. Apparatus according to claim 1, wherein the first conveying device and the second conveying device are chain or belt conveying devices closed in a loop, wherein pendulum support elements arranged in pairs are fixed to the first conveying device and to the second conveying device, with a first support element of each pair arranged on the first conveying device and with a second support element of each pair arranged on the second conveying device, so that each pair of support elements supports opposite ends of a respective support rod.

6. Apparatus according to claim 1, further comprising a third conveying device, placed at an inlet zone of the loading device, and a fourth conveying device, placed at an outlet zone of the loading device, wherein the third conveying device is configured to transfer to the loading device empty support rods and the fourth conveying device is configured to receive from the loading device support rods, loaded with slices of meat.

7. Apparatus according to claim 6, wherein the third conveying device and the fourth conveying device are chain or belt conveying devices that move by steps.

8. Apparatus according to claim 6, wherein the fourth conveyor belt, the fifth conveyor belt, the third conveying device and the fourth conveying device are synchronized with the first conveying device and the second conveying device, so that the latter can move uninterruptedly during the operations of removal of the support rods from the third conveying device, loading the rows of slices of meat onto the support rods and transferring the support rods, loaded with slices of meat (4), onto the fourth conveying device.

9. Apparatus according to a claim 1, further comprising a transferring device, configured to transfer empty support rods from a storage and conveying element to the third conveying device, and to transfer support rods loaded with slices of meat from the fourth conveying device to the storage and conveying element.
